(19) United States
(12) Patent Application Publication
(10) Pub. No.: US 2013/0174489 A1
(43) Pub. Date: Jul. 11, 2013

(54) VIEWING GYRO WINDOW

(71) Applicant: CHENG-TSONG LIN, Taichung City (TW)

(72) Inventor: CHENG-TSONG LIN, Taichung City (TW)

(73) Assignee: Derstrong Enterprise Co., LTD., Taichung City (TW)

(21) Appl. No.: 13/345,708

(22) Filed: Jan. 7, 2012

(51) Int. Cl. E06B 7/28

(52) U.S. Cl. 49/324

(57) ABSTRACT

A viewing gyro window includes a fixing housing, an air-transmitting element, a center bracket, a first driving element having multiple first plates, a second driving element having multiple second plates, and a transparent element attached on the first driving element and the second driving element. A first tunnel and a second tunnel are defined on the center bracket, and are linked through a tube. When the first plates and the second plates are driven by air from the air-transmitting element emitted out of the first tunnel and the second tunnel via the tube, the first driving element and the second driving element rotate simultaneously. Because the transparent element is attached on the first driving element and the second driving element, simultaneous rotations of the first driving element and the second driving element increase a torque and angular velocity of the transparent element so as to accelerate its rotation speed.

### BACKGROUND OF THE INVENTION

1. Field of the Invention

The present invention relates to a viewing gyro window, particularly to an air-driven viewing gyro window.

2. Description of the Prior Art

Traditionally, operating a computer numerically controlled (CNC) machine tool to manufacture mechanical parts always requires coolant. During the processing, the coolant splashes on glass of an observing door and makes it so blurred that operators are not able to observe the processing through the glass of the observing door. As a result, the operator has to open the observing door and clean the glass frequently in order to maintain the processing, which prolongs the processing, increases cost and enhances the operator's risk.

To solve this problem, a use of a viewing gyro window installed on the glass is capable of swinging away the liquid splashed on it. The viewing gyro window comprises a ring frame, a motor disposed at the center of the frame, and glass embedded in the ring frame. The motor drives the glass rotate so fast as to swing away the liquid attached on the glass, which keeps the viewing gyro window clear and prevents the liquid penetrating into the viewing gyro window.

Nevertheless, the electricity-driven motor tends to be corroded in the environment of high humidity for a long time, therefore an air-driven viewing gyro window is an alternative option. An air-driven viewing gyro window comprises a frame having multiple plates and glass embedded in grooves of the frame. When high pressured air squirts onto the plates to push the frame and the embedded glass to rotate in a high speed, the liquid splashed on the glass is swung away due to the centrifugal force, which makes the viewing gyro window clear.

Generally speaking, the faster the glass rotates, the more difficult the liquid attached on the glass. However, if the splashed liquid is a viscous one, such as lubricating oil, so that it tends not to be swung away. After a long time of processing, the viscous liquid accumulates on the glass, which decreases the rotation speed.

### SUMMARY OF THE INVENTION

Accordingly, the purpose of the present invention is to provide an air-driven viewing gyro window of greater torque and angular velocity. The air-driven viewing gyro window comprises a first driving element and a second driving element, both having multiple plates respectively. Two air-transmitting elements, out of which the air is squirted to drive the two driving elements respectively, subsequently lead the transparent elements to rotate. By this way, the torque and change rate of angular velocity per unit time increase. Accordingly, the rotation speed of the transparent element is altered so as to ease the problem of the prior art.

According to the present invention, a viewing gyro window comprises a fixed housing, an air-transmitting element, a center bracket, a first driving element, a second driving element, and a transparent element. The air-transmitting element is used for transmitting air. The center bracket joined to the fixed housing comprises a fixed part, an air receiving part, and a linkage part. The fixed part comprises a first tunnel. The air receiving part joined to the air-transmitting element comprises a second tunnel. The linkage part is used for connecting the fixed part and the air receiving part. The linkage part comprises a tube linking the first tunnel and the second tunnel. The first driving element comprising a plurality of first plates, rotates by drive of air squirting out of the first tunnel. The second driving element comprising a plurality of second plates, rotates by drive of the air squirting out of the second tunnel. The transparent element fastened to the first driving element and the second driving element, rotates as rotation of the first driving element and the second driving element.

In one aspect of the present invention, the air-transmitting element comprises a fitting attaching to an air generator, for receiving air produced by the air generator; and a flow regulator for controlling flow of the air produced by the air generator into the air receiving part.

In one aspect of the present invention, the viewing gyro window further comprises a passive rotation component connecting the first driving element and the center bracket.

In one aspect of the present invention, the passive rotation component comprises a bearing, a first spacer, and a passive rotation fixed housing. The bearing, the first spacer and the passive rotation fixed housing adopt a hole base system or a shaft base system.

In one aspect of the present invention, the air receiving part further comprises a fixed hole, for a fastener penetrating through the fixed hole to fasten the center bracket to the fixed housing.

In one aspect of the present invention, the viewing gyro window further comprises two protection rings placed on the first tunnel and the second tunnel, for sealing a gap between the first tunnel and the passive rotation fixed housing, and for sealing a gap between the second tunnel and the fixed housing, in order to prevent leakage of the air emitted out of the first tunnel and the second tunnel.

In one aspect of the present invention, the viewing gyro window further comprises a center screw, at the center of which set a hollow cylinder with thread inside. The hollow cylinder penetrates through the transparent element, the first driving element, the passive rotation component and the fixed part of the center bracket, with a screw screwed into the hollow cylinder, so that the transparent element, the first driving element and the passive rotation component are fastened to the center bracket.

In one aspect of the present invention, the second driving element is ring-shaped, at edge of which set a groove, where the transparent element embedded.

In one aspect of the present invention, a radius of the first driving element is smaller than a radius of the second driving element.

In one aspect of the present invention, a tilt angle of the first tunnel and the tube, and a tilt angle of the second tunnel and the tube are within 30 to 60 degree.

These and other features, aspects and advantages of the present disclosure will become understood with reference to the following description, appended claims and accompanying figures.

### BRIEF DESCRIPTION OF THE DRAWINGS

FIG. 1 shows an air-driven viewing gyro window is defined on a transparent panel according to the present invention.

FIG. 2 shows a decomposition diagram of the air-driven viewing gyro window according to the present invention.

FIG. 3 shows a perspective view of the center bracket in FIG. 2.

FIG. 4 shows a top view of the air-driven viewing gyro window in FIG. 2.

FIG. 5 shows a cross-section view along the line A-A′ of the viewing gyro window shown in FIG. 4.

FIG. 6 shows a cross-section view along the line B-B′ of the viewing gyro window shown in FIG. 4.

FIG. 7 shows a cross-section view along the line C-C′ of the viewing gyro window shown in FIG. 4.

FIG. 8 shows an assembly drawing of an embodiment of the air-driven viewing gyro window 100 before being installed on the transparent panel.

FIG. 9 shows a side view of an embodiment of the air-driven viewing gyro window before being installed on the transparent panel shown in FIG. 8.

FIG. 10 shows another assembly drawing of an embodiment of the air-driven viewing gyro window before being installed on the transparent panel.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

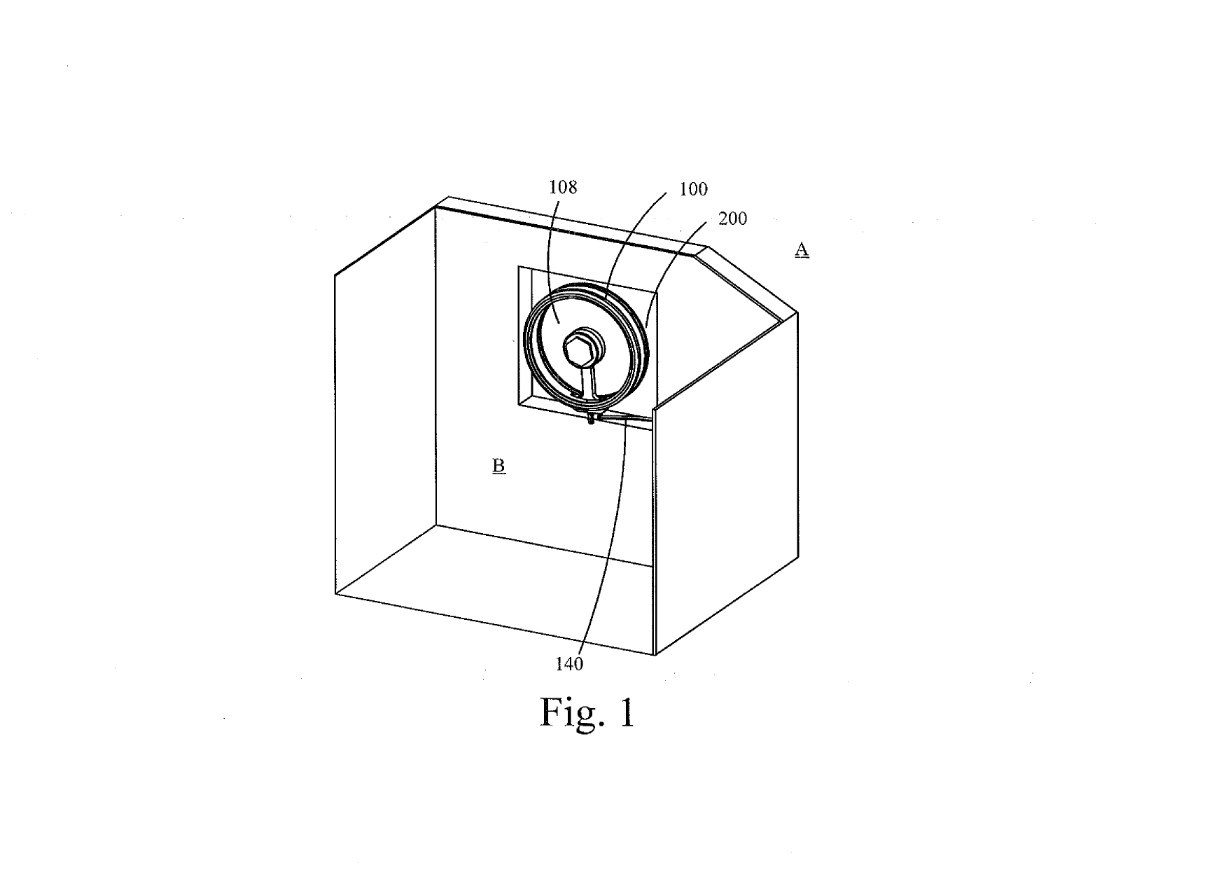

FIG. 1 shows an air-driven viewing gyro window 100 is defined on a transparent panel 200 according to the present invention. The viewing gyro window 100 may be defined on the transparent panel 200 of a CNC machine tool or a vessel. Through an air-transmitting elements 140, air is transmitted and emitted to drive a transparent elements 108 into high speed rotation, so as to swing away the liquid splashed on the transparent elements 108. As a result, a user can see situation in space B from space A via the air-driven viewing gyro window 100.

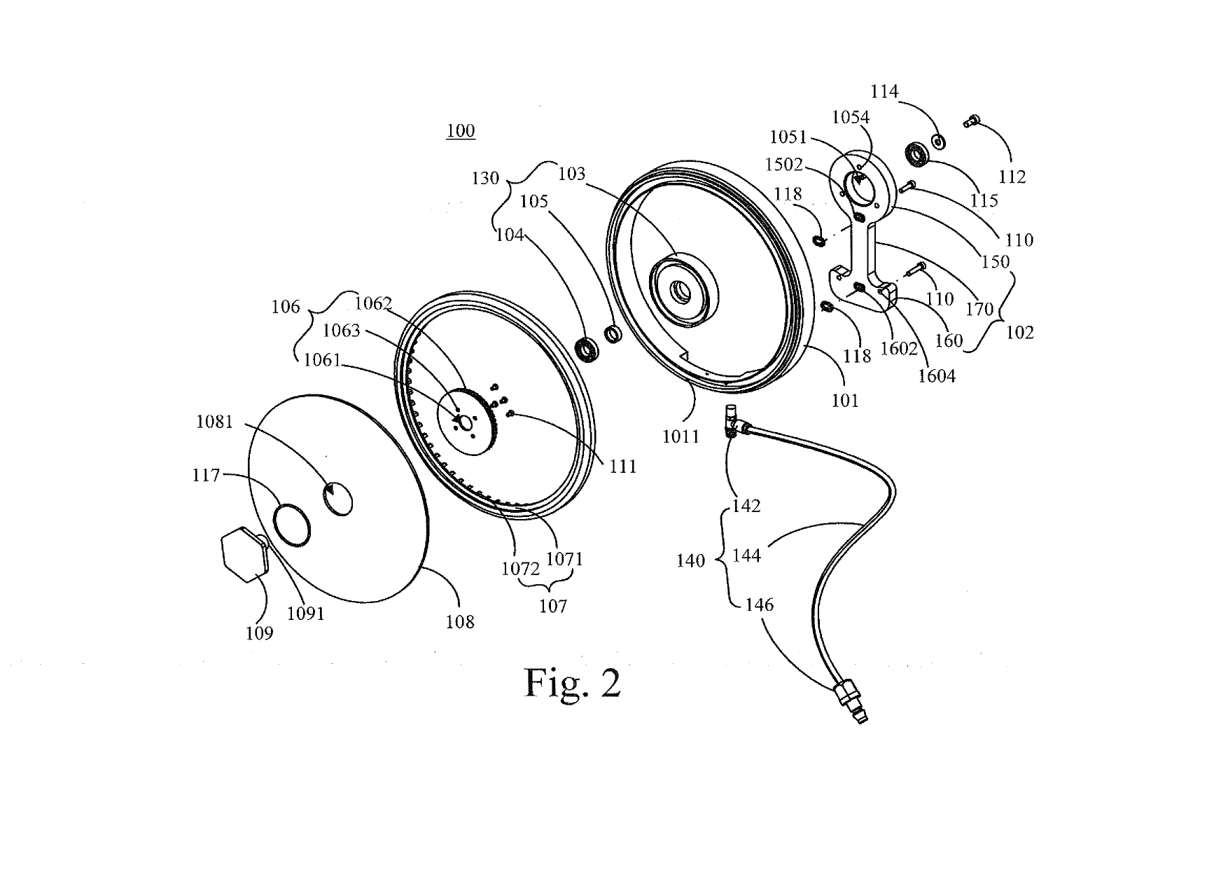

FIG. 2 shows a decomposition diagram of the air-driven viewing gyro window according to the present invention. The viewing gyro window 100 comprises a fixed housing 101, a center bracket 102, a passive rotation component 130, a first driving element 106, a second driving element 107, a transparent element 108, a center screw 109, a spacers 105, a washer 114, a bearing 115, an air-transmitting element 140, a waterproof ring 117, two protection rings 118, and multiple screws 110, 111, 112.

The second driving element 107 is a ring, inside which a groove 1071 is defined. The ring-shaped second driving element 107 also comprises multiple plates 1072. An opening 1081 is located at the center of the transparent element 108 and defined on the groove 1071 of the second driving element 107. It is preferred that the transparent element 108 is made of reinforced glass or plastic.

The first driving element 106 is a circular plate, which comprises an opening 1061 located at its center and multiple screw holes 1063 around the opening 1061. The radius of the first driving element 106 is smaller than that of the second driving element 107. Multiple plates 1062 are defined on the first driving element 106.

The passive rotation component 130 comprises a passive rotation fixed housing 103, a bearing 104 and a spacers 105. The passive rotation fixed housing 103, the bearing 104, and the spacers 105 are ring-shaped, at the center of which an opening is defined respectively. Preferably, the passive rotation component 130 is composed of theses above-mentioned parts adopt a hole base system or a shaft base system.

The fixed housing 101 has a groove 1011 for the installation of the second driving element 107.

The center bracket 102 has a fixed part 150, an air receiving part 160, and a linkage part 170 connecting the air receiving part 160 with the fixed part 150. The fixed part 150, the air receiving part 160 and the linkage part 170 are in one piece.

The fixed part 150 comprises an opening 1051 located at its center, a first tunnel 1502, and multiple fixed holes 1054. The emitting opening of the first tunnel 1502, via the tube of the passive rotation fixed housing 103, corresponds to the plates 1062 of the first driving element 106.

The air receiving part 160 connects to an air-generator (not shown), via the air-transmitting element 140. The air-transmitting element 140 comprises a flow regulator 142, a hose 144 and a fitting 146. The fitting 146 attaches to the air-generator so that the air produced by the air generator via the hose 144 transmitted into the air-incidence part 160. The flow regulator 142 controls the air flow. The air receiving part 160 also comprises a second tunnel 1602 and at least a fixed hole 1604.

The emitting opening of the second tunnel 1602, via the tube of the passive rotation fixed housing 101, corresponds to the plates 1072 of the second driving element 107. A fastener, such as the screw 110, penetrating through the fixed hole 1604 and the fixed hole 1504, is screwed to a corresponding screw hole (not shown) of the fixed housing 101, which fastens the center bracket 102 to the fixed housing 101.

The center screw 109 defines a hollow cylinder 1091 at its center. The hollow cylinder 1091 has thread (not shown) inside of it. In composition, the waterproof ring 117 and the transparent element 108 are laid between the center screw 109 and the first driving element 106, and then multiple screws 111, penetrating through the screw hole 1063 of the first driving element 106 and the opening 1081 of the transparent element 108, are screwed to the center screw 109. As a result, the transparent 108 is clipped up by the first driving element 106 and the center screw 109. The waterproof 117 seals the tiny gap between the center screw 109 and the transparent element 108, to prevent water and moisture.

Simultaneously, the hollow cylinder 1091 of the center screw 109 sequentially passes through the waterproof ring 117, the opening 1081 of the transparent element 108, the opening 1061 of the first driving element 106, and the passive rotation component 130, and the center bracket 102. Afterwards, the screw 112 is plugged into and screwed into the hollow cylinder 1091. Consequently, the waterproof ring 117, the opening 1081 of the transparent element 108, the first driving element 106, and the passive rotation component 130 are fastened to the center bracket 102 by the screw 112.

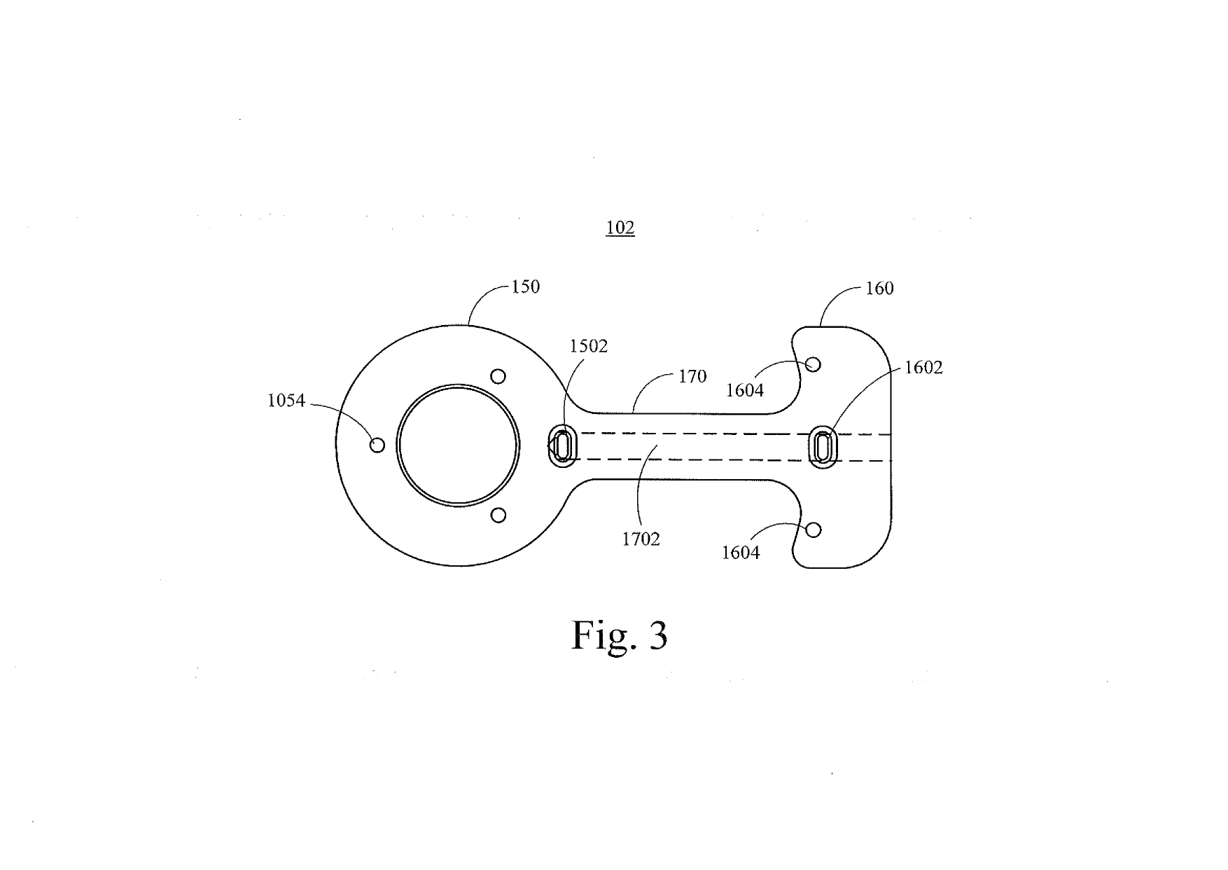

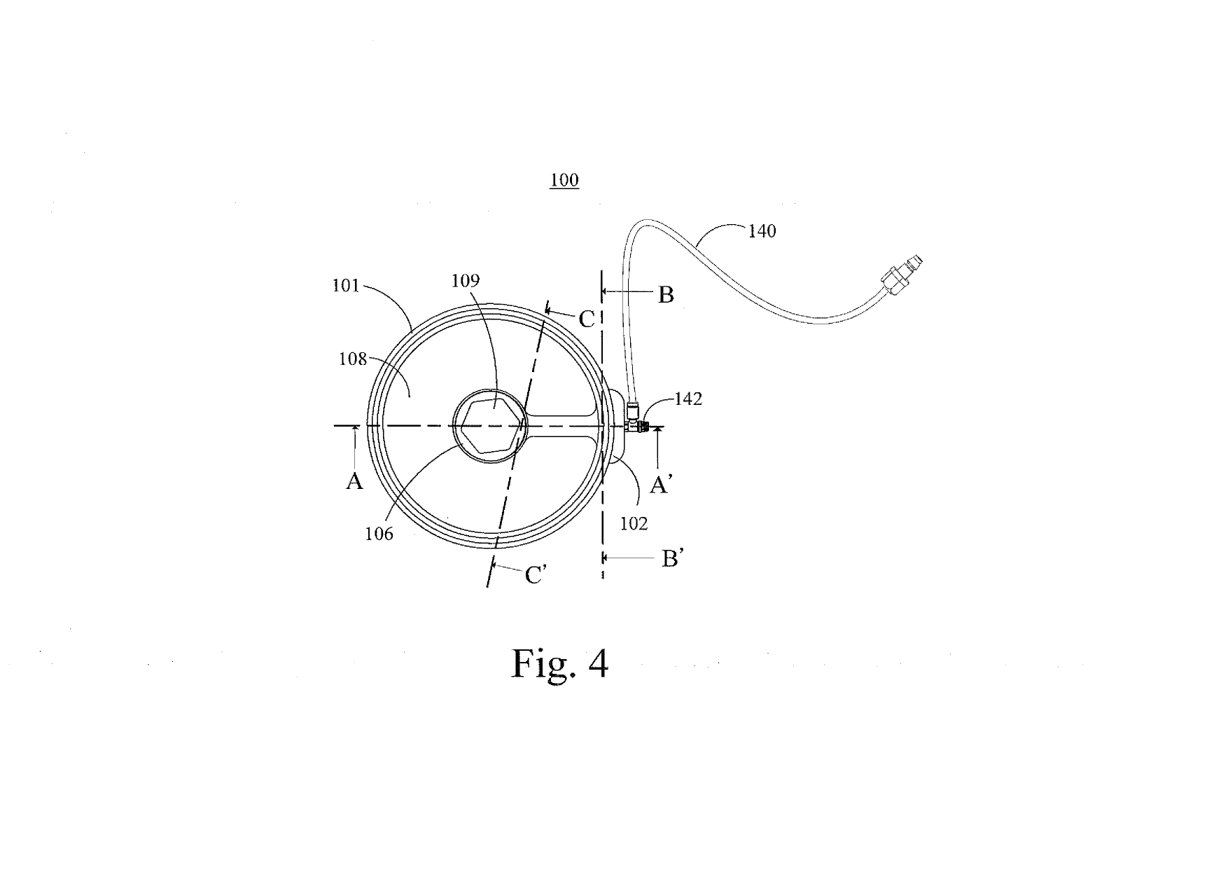

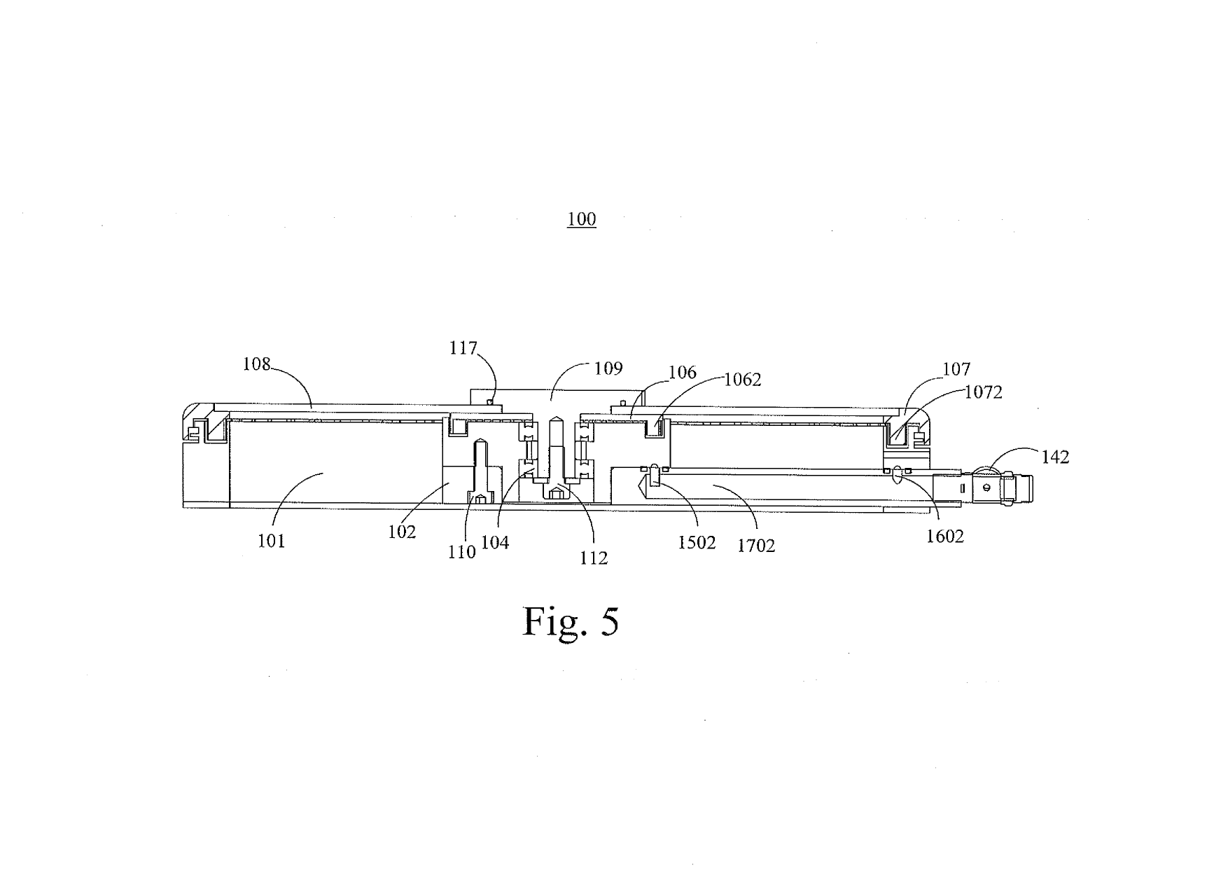

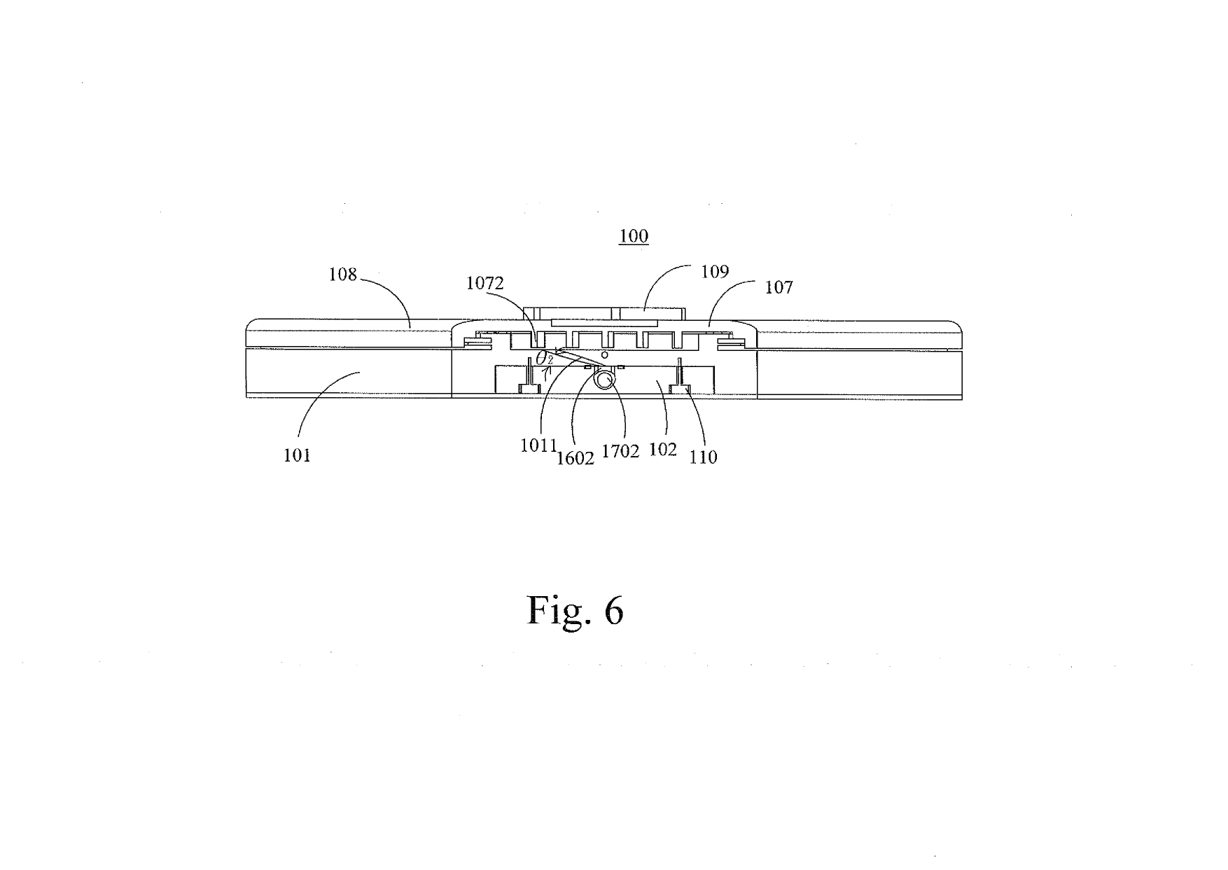

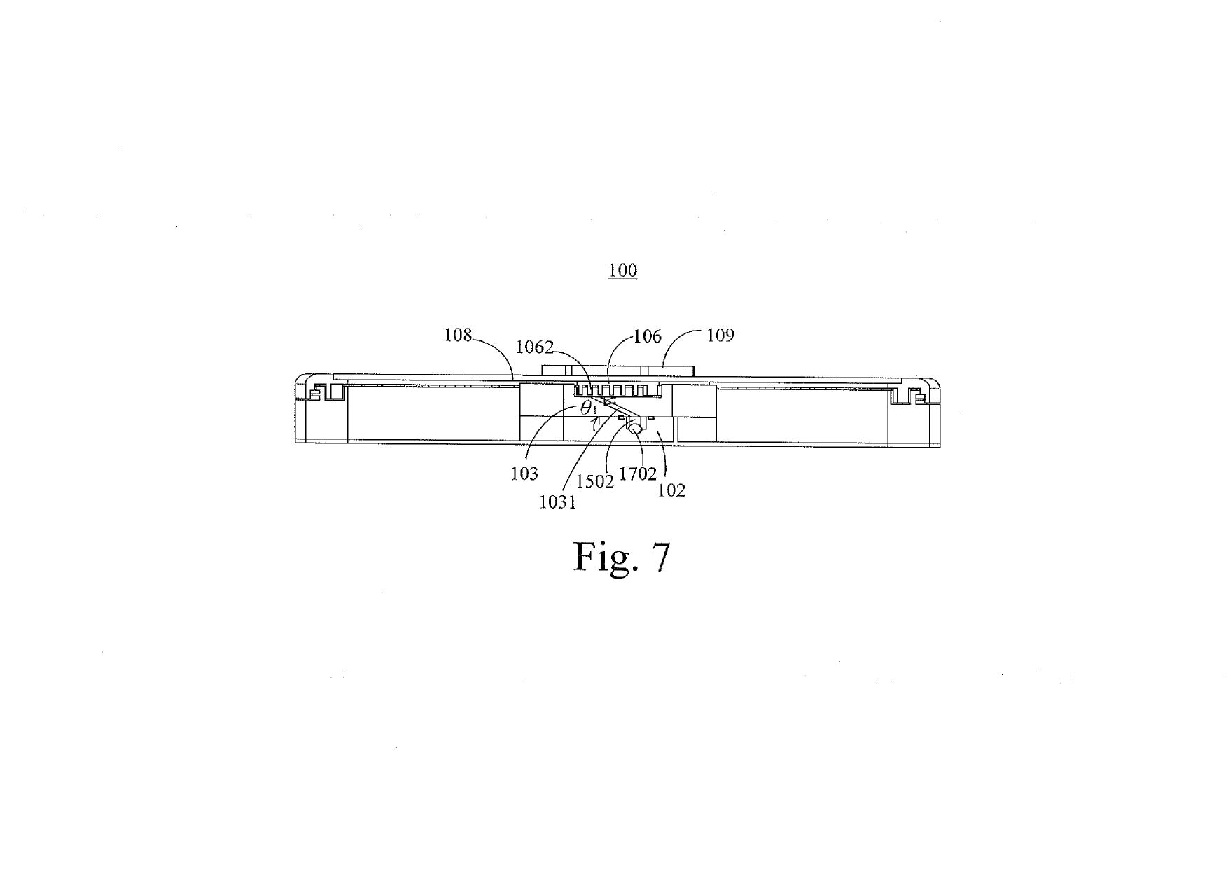

Refer to FIG. 3 to FIG. 7. FIG. 3 shows a perspective view of the center bracket 102 in FIG. 2. FIG. 4 shows a top view of the air-driven viewing gyro window 100 in FIG. 2. FIG. 5 shows a cross-section view along the line A-A′ of the viewing gyro window shown in FIG. 4. FIG. 6 shows a cross-section view along the line B-B′ of the viewing gyro window shown in FIG. 4. FIG. 7 shows a cross-section view along the line C-C′ of the viewing gyro window shown in FIG. 4. A tube 1702 is set inside the linkage part 170. The tube 1702, connecting the first tunnel 1502 and the second tunnel 1602, receives the air emitting from the air transmitting element 140 and expels the air out of the first tunnel 1502 and the second tunnel 1602. Referring to FIG. 7, θ₁ refers to the tilt angle between the first tunnel 1502 and the passive rotation component in the extension line of the tube 1702, while θ₂ refers to the tilt angle between the second tunnel 1602 and the fixed housing in the extension line of the tube 1702. Because θ₁ and θ₂ are within 30 to 60 degree, the emitting air can drive the rotation of the plates 1062, 1072 more efficiently.

Referring to FIG. 2, the two protection rings 118, placed on the first tunnel 1502 and the second 1602, seal the tiny gap between the first tunnel 1502 and the passive rotation fixed housing 103, and the gap between the second tunnel 1602 and the fixed housing 101, to prevent leakage of the air expelled out of the first tunnel 1502 and the second tunnel 1602. Without the protection rings 118, the air flow driving the first driving element 106 and the second driving element 107 may decrease due to the air leakage

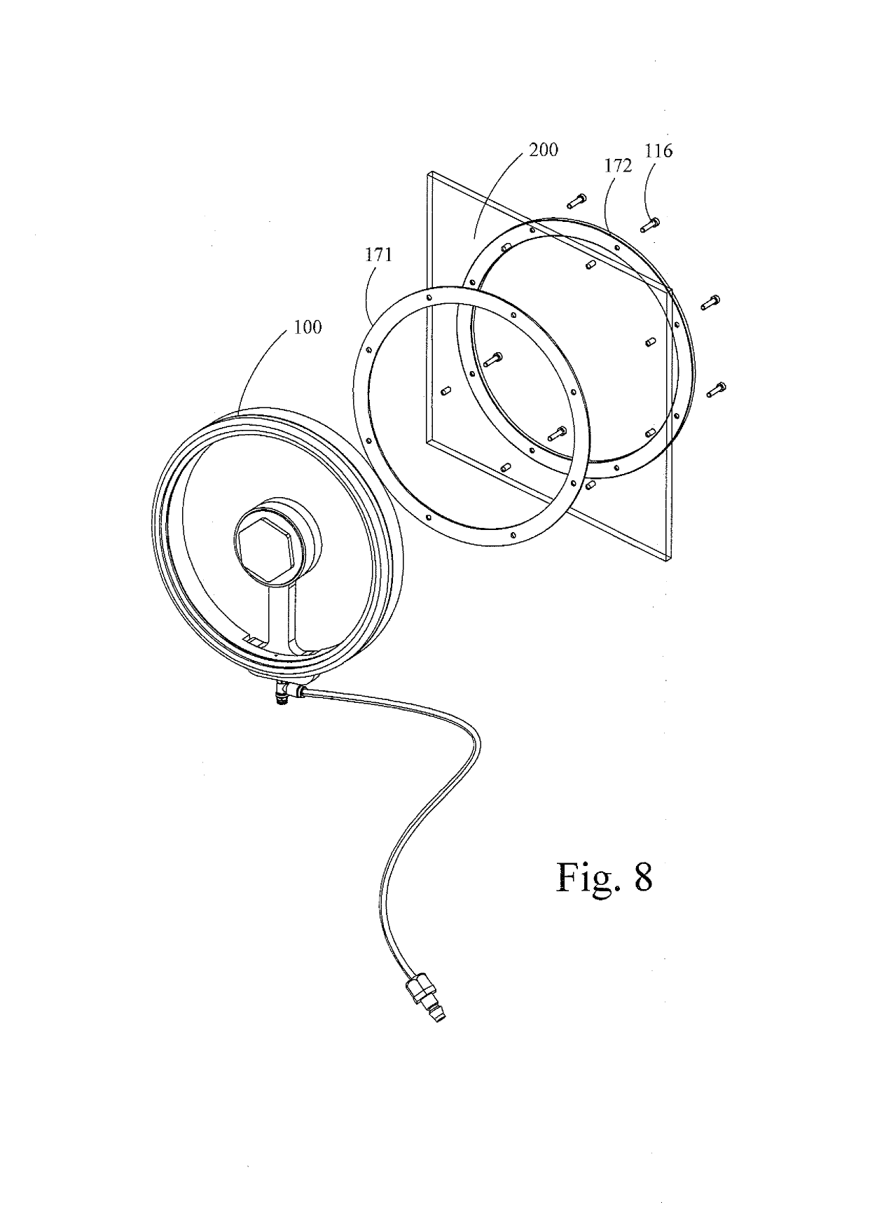

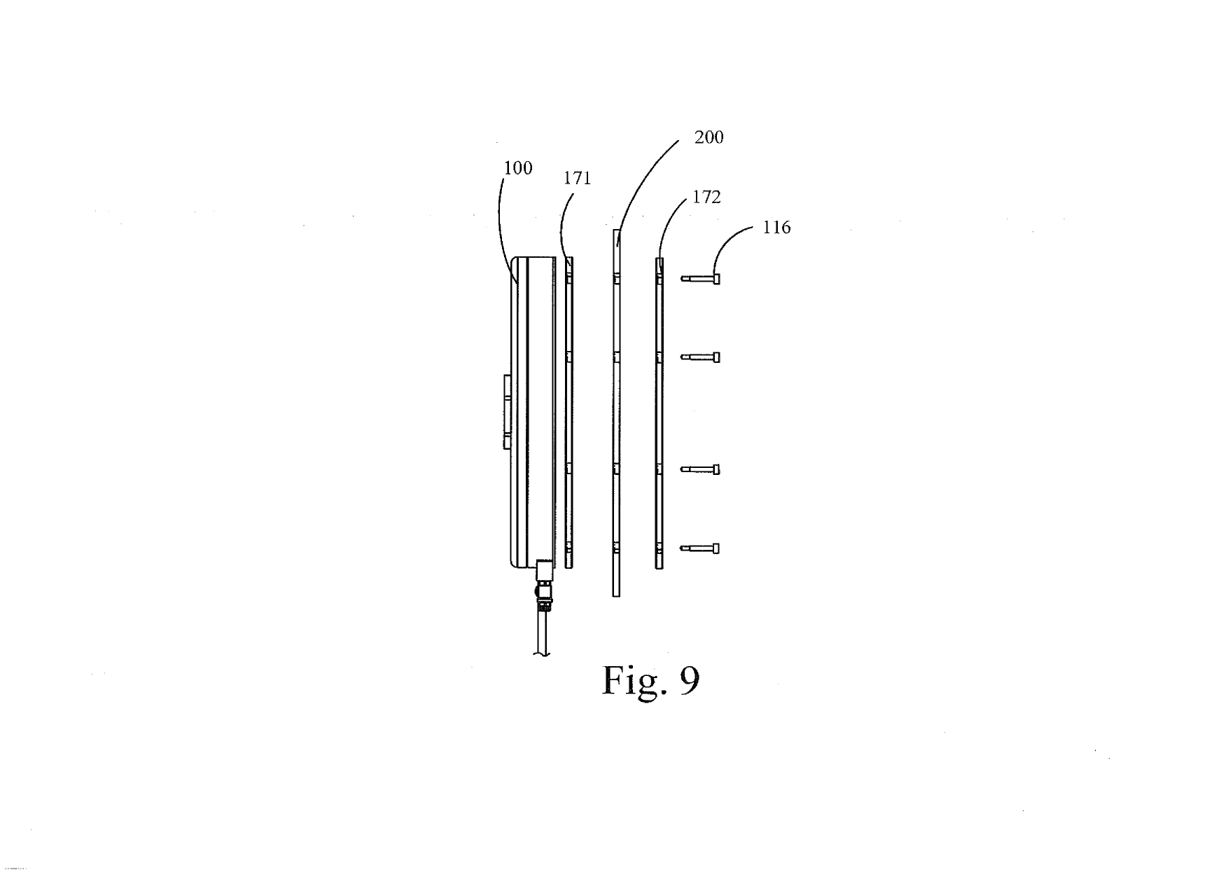

Referring to FIG. 8 and FIG. 9, FIG. 8 shows an assembly drawing of an embodiment of the air-driven viewing gyro window 100 before being installed on the transparent panel 200. FIG. 9 shows a side view of an embodiment of the air-driven viewing gyro window 100 before being installed on the transparent panel 200 shown in FIG. 8. After assembly of the viewing gyro window 100, it can be, with a first gasket 171 and a second gasket 172, fastened to the transparent panel 200 with the screw 116. The first 171 and the second 172 can be plastic or rubber in a better way.

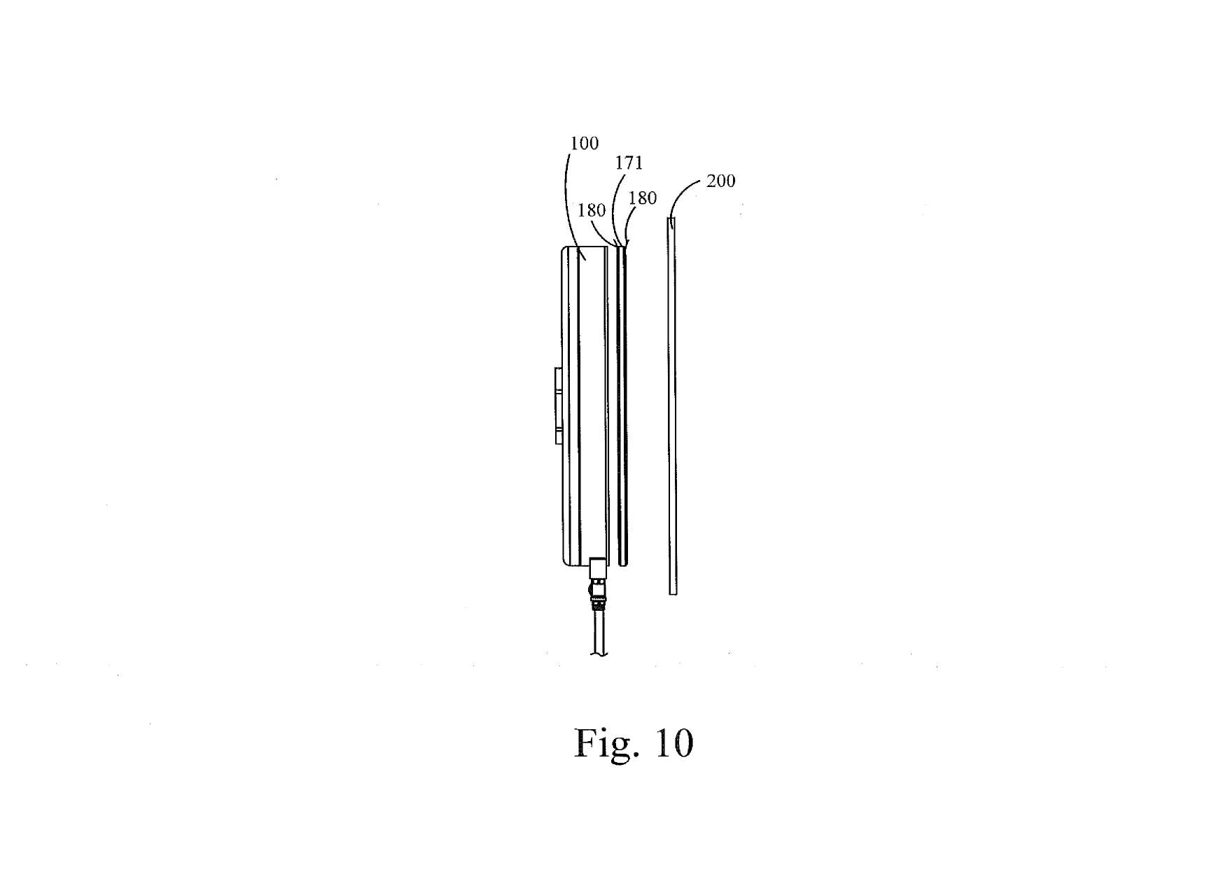

Referring to FIG. 10, FIG. 10 shows another assembly drawing of an embodiment of the air-driven viewing gyro window 100 before being installed on the transparent panel 200. In the embodiment, instead of the second gasket 172, a glue 180 is pasted on both sides of the first gasket 171, and makes the viewing gyro window 100 and the transparent panel 200 attached to each side of the first gasket 171 respectively.

In contrast to prior art, the air-driven viewing gyro window of the present invention defines a first driving element and a second driving element, both having multiple plates respectively. The two driving elements are respectively driven by air squirted out of two air-emitting openings. Having two driving elements lead the rotation of the transparent elements, the rotation speed of the transparent elements is altered, and the greater change rate of angular velocity per unit time and torque can be maintained even if heavier load is on the transparent elements. In this way, the problem of the prior art can be eased.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A viewing gyro window comprising:
a fixed housing;
an air-transmitting element for transmitting air;
a center bracket joined to the fixed housing, comprising:
a fixed part comprising a first tunnel;
an air receiving part joined to the air-transmitting element, comprising a second tunnel; and
a linkage part for connecting the fixed part and the air receiving part, comprising a tube linking the first tunnel and the second tunnel;
a first driving element comprising a plurality of first plates, rotating by drive of air squirting out of the first tunnel;
a second driving element comprising a plurality of second plates, rotating by drive of the air squirting out of the second tunnel; and
a transparent element fastened to the first driving element and the second driving element, rotating as rotation of the first driving element and the second driving element.

2. The viewing gyro window of claim 1 wherein the air-transmitting element comprises:
a fitting attaching to an air generator, for receiving air produced by the air generator; and
a flow regulator, for controlling flow of the air produced by the air generator into the air receiving part.

3. The viewing gyro window of claim 1 further comprising a passive rotation component connecting the first driving element and the center bracket.

4. The viewing gyro window of claim 1 wherein the passive rotation component comprises:
a bearing;
a first spacer; and
a passive rotation fixed housing;
the passive rotation component being composed of the bearing, the first spacer and the passive rotation fixed housing adopting a hole base system or a shaft base system.

5. The viewing gyro window of claim 1 wherein the air receiving part further comprises a fixed hole, for a fastener penetrating through the fixed hole to fasten the center bracket to the fixed housing.

6. The viewing gyro window of claim 1 further comprising two protection rings placed on the first tunnel and the second tunnel, for sealing a gap between the first tunnel and the passive rotation fixed housing, and for sealing a gap between the second tunnel and the fixed housing, in order to prevent leakage of the air emitted out of the first tunnel and the second tunnel.

7. The viewing gyro window of claim 6 further comprising:
a center screw, at the center of which set a hollow cylinder with thread inside, the hollow cylinder penetrating through the transparent element, the first driving element, the passive rotation component and the fixed part of the center bracket, with a screw screwed into the hollow cylinder, the transparent element, the first driving element and the passive rotation component being fastened to the center bracket.

8. The viewing gyro window of claim 6 wherein the second driving element is ring-shaped, at edge of which set a groove, where the transparent element embedded.

9. The viewing gyro window of claim 8 wherein a radius of the first driving element is smaller than a radius of the second driving element.

10. The viewing gyro window of claim 1 wherein a tilt angle of the first tunnel and the tube, and a tilt angle of the second tunnel and the tube are within 30 to 60 degrees.
